(19) United States
(12) Patent Application Publication
(10) Pub. No.: US 2022/0163038 A1
(43) Pub. Date: May 26, 2022

(54) Triple bullet magnet in wing gate design in electromagnetic motor assembly

(71) Applicant: Douglas David Duncan, Virginia Beach, VA (US)

(72) Inventor: Douglas David Duncan, Virginia Beach, VA (US)

(21) Appl. No.: 17/105,606

(22) Filed: Nov. 26, 2020

(51) Int. Cl. F04D 25/06; H02S 40/38

(52) U.S. Cl. CPC F04D 25/06; B60K 8/00; H02S 40/38

(57) ABSTRACT

Disclosed is a unique Triple bullet (shaped) magnet in wing gate design with a specific array with an electromotor assembly, which is made up of up to 4 rotating triple bullet magnet arms spaced equally apart, at 90 degrees for the 4 arm triple bullet magnet, in rotary motion, maintaining motion within the 5 spatially fixed wing gates regarding their orientation in the circle, but laterally mobile.

The electromotor assembly includes receiving power from the specific solar panel array, stored and utilized power maintained and transferred into and out of the supercapacitor bank, and utilizes a one-way gate to guide electrical power from the solar type power array to the supercapacitor bank. The supercapacitors also utilize energy production from the rotary engine component through an electromagnetic generator and other corresponding energy conservation. These provide power to the electronics in the system or machine, as well as drive fans or otherwise.

### BACKGROUND

### 1. Field of the Invention

The invention relates generally to triple bullet magnet in wing gate design in electromagnetic motor assembly and system for energy amplification.

### 2. Background

Currently, there are a number of solutions for motors and for powering machines. Some of these solutions attempt to augment or power their engine with gasoline or diesel or other fuels, but these solutions fail to meet the needs of the industry because the environmental and resource and world conflict problems created from using petroleum products or these types of combustible fuels. Other solutions attempt to use lithium or other types of batteries, but these solutions are similarly unable to meet the needs of the industry because the batteries half-life or longevity is sub-optimal, can be a fire hazard, are electrochemical in nature, and are a potential waste or disposal hazard. Still other solutions seek to use alternate power, but these solutions also fail to meet industry needs because they have not been able to fulfill the industry standard.

### SUMMARY OF THE INVENTION

This is the nonprovisional patent application in reference to the provisional version that was filed on 4 Feb. 2020 with EFS ID, 38483670, application No. 62/069,723, confirmation number, 3757, “Triple Bullet Magnet in Wing Gate Design and electromotor assembly by myself, Dr. Douglas David Duncan, same address and correspondence.

It is desirable to have a triple bullet magnet in wing gate design and electromotor assembly and system for energy amplification which can utilize the attractive capabilities and natural abilities of magnetic, solar, and natural energy to power and sustain the electromotor assembly to be utilized for a car or transport or any machine for power or energy or motion as needed. Furthermore, it is desirable to have a triple bullet magnet in wing gate design and electromotor assembly and system for energy amplification including the solar panel and array and supercapacitor bank and turbine fan design with electromagnetic machine integrated to power any machine to decrease our dependence on oil, coal, petroleum type products, or often similarly classified fuels. This will help to decrease our so called “carbon footprint” and emissions or pollution that could be damaging our environment. Still, further, this would decrease our potential dependence on foreign oil and help neutralize a potential natural funding source, (purchasing overseas oil), for Middle East terrorism and other hostile areas, taxing our resources, soldiers, lives, and national security in the United States. Also it avoids the problems, limitations, potential dangers, and waning lifespans that is inherent to battery dependent devices, and to include and consider potential hazards of waste disposal and weather performance limitations as well. The disclosed device advantageously fills these needs and addresses the aforementioned deficiencies by providing a clean, natural, and US protected triple bullet magnet in wing gate design and electromotor assemble and system for energy amplification utilizing the special solar or ultraviolet panel array, supercapacitor bank, and assemble with turbine fan design and integrated electromagnetic motor to provide a sustainable power source to power our cars, machines, transport devices, and otherwise.

Disclosed is a Triple bullet (shaped) magnet in wing gate design with a specific array with an electromotor assembly, which is made up of the following components of up to 4 rotating triple bullet magnet arms that would be spaced equally apart, at 90 degrees for the 4 arm triple bullet magnet component described here, in rotary motion and capable of making and maintaining rotary motion within the 5 spatially fixed wing gates. There are 5 wing gates at fixed locations spaced accordingly beginning at the 0 degree mark at the top of the upright rotary apex, and proceeding with the following, the 105 degree mark going “downhill” with gravity, at the 180 degree mark (+75 degrees from the previous, at the 210 degree mark (+30 degrees from the previous and now going “uphill” against gravity), at the 270 degree mark (plus 60 degrees from the previous), and back to the original 0 degree or 360 degree mark when the rotary design begins (plus 90 degrees from the previous). The wing gates are comprised of two identical gates, mirroring each other with a specific and mirrored array of magnets as detailed. The wing gates are in fixed positions regarding their rotary position but have the ability to move laterally to optimize speed, performance, and efficiency. There is an electromagnet positioned variably pointing 25 degrees up from the perpendicular point (from the tangential) located at approximately the 225 degree mark (or 45 degrees uphill from the 180 degree mark) positioned outside the rotary unit, utilized to deliver timed repulsion magnetic field bursts via a reed switch to help accelerate or provide torque producing power to the unit as a triple bullet magnet arm goes “uphill” against gravity or helping to control speed or velocity overall. A 2^{nd} electromagnet pulse generator is added at the 315 degree mark with corresponding reed switch at the 45 degree mark, but either electromagnetic pulse generator and corresponding reed switches can be variable in location and number depending on the machine build, spacing requirements, and motor assembly needs. The rotary assembly also utilizes momentum or inertia shift which can be in the form of liquid or mobile units that assist in balanced momentum or inertia transfer in the gravity model or otherwise and utilized or added as needed. The electromotor assembly includes receiving power from the specific solar panel array, stored and utilized power maintained and transferred into and out of the supercapacitor bank, and utilizes an NPN type electric circuit gate or similar one-way gate to guide electrical power from the solar type power array to the supercapacitor bank. The supercapacitors are also charged utilizing energy production from the rotary engine component through an electromagnetic generator and corresponding circuit and array. These provide power to the electronics in the car or transport or system/machine, as well as is utilized to drive fans or torque to the drivetrain, axle, wheels and corresponding gear box or otherwise. The system is appropriately cooled with the coolant system and the braking system provides control, deceleration, and energy conservation. Energy is also potentially utilized from the coolant system energy conservation and conserved from the electromotor pulse force generated left regenerated from the retropulsion force from the electromagnetic motor in an energy conservation cycle. The electromotor assembly includes electric generation or conservation (electromagnetic) coils placed well to capture energy from torque or motion and delivered to the supercapacitor or are in areas as needed.

These components are connected as follows. The solar panel array collects energy with electric current traveling through the NPN type junction gate and stored in the supercapacitor bank. The electric NPN potential is protected by a gate keeping supercapacitor as well. An electromagnet motor receives power from the supercapacitor bank and can initiate revolutions of the triple bullet (shaped) magnet arms within the wing gates. Velocity and torque can be controlled by the electromagnetic motor input and lateral variability of the wing gates as well as a braking mechanism (mechanical and electric) and the electromagnetic pulse generator connected to reed switches with controls. As the rotary assembly produces power via an electromotor generator, this is distributed as appropriate to use in the car, machine, transport, or device or stored in the supercapacitor bank. The power also utilizes the torque via an electromagnetic motor to drive the axle and wheels via a gear box and drivetrain and can also drive fans to assist in mobility in any manner as utilized or needed. The coolant system maintains the system at the proper temperature and can be utilized to conserve energy as well. The system uses well placed copper or wire coils to capture electric energy produced by revolutions and can utilize the energy or store it in the supercapacitor bank. The braking system is utilized at the wheels, fans, and electromagnetic motor in the form of electrical controls and physical or mechanical braking utilized as well and utilizes energy conservation back into the supercapacitor bank or as needed and otherwise.

The device may also have one or more of the following: The solar panel array may be made of aluminum with a silica base central where a copper wire is laid on or in the base, but can be variable. The copper wires from each unit or aluminum fold leads past a circuit gate which may include an NPN type junction leading to the supercapacitor bank. Each segment or aluminum structural fold may have titanium oxide painted on the top outer portion. Each fold may be covered in a polycarbonate or other scratch resistant material maximizing the solar type energy entering while providing maximum practical protection and scratch resistance. The supercapacitors may be made of a graphene type material or another form of carbon or otherwise. The electromagnet repulsion pulse generator can be positioned variably on the rotary assembly and there is at least one. There are options regarding how the triple bullet arms are arranged in number and position, but they are equally spaced. There could be some potential variation in the gate positioning and number, but they are not equidistant. The device and assembly can be used to power a car or transport by traditional means through a gear box and drivetrain or it can variably include fans as well at the base of the car and also at the front and rear. The assembly could be used to power any transport or machine. Some fans are turbine fans with the electromotor assembly integrated.

The disclosed device is unique when compared with other known devices and solutions because it provides (1) a unique triple bullet magnet in wing gate design and electromotor assembly; (2) complete clean power that is sustainable with the structure of the electromagnetic motor and assembly and solar panel array; and (3) without the use of batteries.

The disclosed device is unique in that it is structurally different from other known devices or solutions. More specifically, the device is unique due to the presence of (1) The triple bullet (shaped) magnet arm in its array in wing gate design and its array and layout and assembly; (2) the configuration of the solar panel array, junction gate, and use of supercapacitor bank alongside the power generated by the electromagnetic motor and assembly; and (3) use of fans or conventional drive train or combination as powered by the energy produced in the manner produced and stored and utilized in the supercapacitor bank and transmitted via the electromagnetic motor and ability to power a car, transport, or any machine in this manner.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The Triple bullet magnet in wing gate design in electromagnetic motor assembly may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1.—Portrait View—Shows an overview of the Triple Bullet Magnet in wing gate design and electromotor assembly and system for energy amplification. A) Shows the inline or sagittal view of the Triple bullet magnet in wing gate design and beginning of electromagnetic assembly that generates power B1.) Shows a lateral view or coronal view of the triple bullet magnet in wing gate design, showing a more central view highlighting the triple bullet magnet side view within the wing gates B2.) This shows a more lateral view of the lateral or coronal view, highlighting one of the more lateral wing gates side view C.) Shows a top down or aerial view of the triple bullet magnet in wing gate design D.) Shows a side or lateral view, coronal view of the full array, highlighting 4 Triple bullet magnet arms spaced, evenly, 90 degrees apart in rotary motion and the 5 wing gates at specific and unique interval spacing alongside the electromagnet pulse generator and components, and also showing a coolant system and pulse generators for speed control E.) Shows the solar panel array and design with the triangular panels in the car or transport or machine exterior with folded or variegated aluminum structure with silicone wedge at base or valley of each fold with copper wire and polycarbonate protective top and titanium dioxide paint outside the silicon Wedge base alongside transport of the electrical energy through an NPN type gate to the semiconductor bank (SC) F). Shows electronics being powered by the system G.) Shows a drivetrain being powered by system H.) Shows fans being powered by the system to be utilized in multiple purposes or transport or machines I.) Shows a car body, the base, or transport with fans and turbine type fan utilizing electromagnet assembly components and car, as a machine, powered in the base and front and rear.

FIG. 2.—Landscape View—Same overview as above

FIG. 3.—(FIG. A Focus)—Sagittal or in line view Triple bullet magnet in wing gate design—shows Triple bullet magnet in motion into the page inside the wing gate design and array and lateral movement capability of the wing gate—connected and turning shaft for electromotor energy—electrical output.

FIG. 4.—(FIG. B1-B2 Focus)—Lateral or coronal view of the Triple Bullet Magnet in wing gate design. B1 shows a more central view that highlights the side view of the triple bullet magnet showing the bullet shaped magnets on the rotating arm. The 1st and 3rd magnets are aligned similarly with their poles in the same direction and the middle bullet shaped magnet has its poles aligned the opposite of the other two. The outline of the wing gate array is shown as a box around as a reference point to show the magnets passing in between 2 lateral gates. B2 shows the more peripheral or more lateral view of the side or lateral or coronal view of the wing gate design and array. It is a more detailed representation of the array of the wing gates and alignment of magnets and their respective poles within the make-up of the two wing gates. There is a wing gate on either side of the rotary bullet magnet arms as they are in motion past each gate.

FIG. 5.—(FIG. C Focus)—Top down or aerial view of a bullet magnet rotary arm passing between a stationary wing gate and wing gate array. The bullet arm has forward rotary movement and the wing gates have lateral movement capability toward the bullet shaped magnet arm or away.

FIG. 6.—(FIG. D Focus)—This is the overall lateral view showing the 4 arms of the triple bullet magnet in rotary motion through the 5 wing gates. The 4 bullet shaped magnet arms are spaced evenly at 90 degrees apart in this model drawing (but could be 2 or 3 arms) and the 5 wing gate design showing the upright model with the first gate at the 0 degree mark at the top, the 2nd gate at the 105 degree mark going “downhill” with gravity, the 3rd gate on the 180 degree mark (plus 75 degrees from the previous), the 4th gate at the 210 degree mark (plus 30 degrees from the last one, and the 5th gate at the 270 degree mark (plus 60 degrees from the prior gate), taking us back to the 0 degree or 360 degree mark back up top (90 degrees from the 5th gate). There is an electromagnetic repulsion pulse generator, generated at the, variably, 45 degree mark going “uphill” from gravity past the 4th gate (at the 225 degree mark overall), and also angled variably, pitched to 25 degrees, upwards angle, to facilitate generating torque and acceleration and velocity control of the triple bullet magnet rotary arm in wing gate design and corresponding second position at 310 degrees. There is a coolant system to cool this system, and power generated in the assembly is coupled to generate power to the drivetrain, and or fans, electronics, machine, or supercapacitor bank via the electromagnet motor system to be stored and distributed as needed or appropriate. This represents the triple bullet magnet in wing gate design in the overall format, design, or assembly, or associated configuration.

FIG. 7.—(FIG. E Focus) Shows the corresponding solar type, clean energy array, such as ultraviolet or otherwise, that is structurally built into the integrity of the body, such as comprising the structure of the car or transport or machine. It is primarily an aluminum folded or variegated structure, with a ‘V’ or wedge shaped silica base at the depth or base of each groove in the depth or base of each fold, alongside copper wiring in that groove, separated from the aluminum on or within the silica base. There is titanium oxide painted outside the silica on the edges of the aluminum as the told goes out to the top or apex of each fold. Covering the top of each V at the apex is a canopy of polycarbonate or similar and maximally productive scratch resistant substance transmitting the energy, light, or ultraviolet into each fold, which generates electricity and is channeled through a one way type gate, such as an NPN gate channel, and charging the supercapacitor bank to be distributed as needed or directed as called or utilized. The top 3 units diagrammed are seen, (such that they are V-shaped units at top of page with straight lines down representing the copper wires coming down from each and a curved canopy shaped window superior, on the top edge of each, which transmits the light and focuses the energy and provides some protection and energy conservation in a greenhouse effect). These 3 figures connected in a row show a cut out or blow-up example of the V shape, topped with a substance such as a polycarbonate or scratch resistant light permitting material, (3 in a row in this example representative of the ongoing and continuous variegated design pattern), where the silica base is wedged at the base of the groove and titanium oxide paint on the sides outside the silica base, along with the trailing lines inferiorly showing or representing the copper wiring leading out (in a representative way via the diagram schematic) and delivering electricity—via the one way electrical gate channel (NPN as a one way gate type example)—to the supercapacitor bank below. This can then feed into or give power as needed to the supercapacitor bank and on toward the rest of the assembly.

FIG. 8.—(FIG. F. Focus)—Shows the supercapacitor bank and such that it can supply power to any number of items within the car, transport or machine such as the representative electronics and electronic systems and power otherwise to or harnessed in the car, transport, or machine.

FIG. 9.—(FIG. G Focus)—Shows the drivetrain of the car or transport and gear box powered by the triple bullet magnet in wing gate assembly and electromotor assembly and system for energy amplification with torque and drivetrain capabilities—alongside the write up at the bottom of the diagram which includes more written detail on wing gate design.

FIG. 10.—(FIG. H Focus)—Shows a fan or machine being powered by the Triple bullet magnet in wing gate design and electromagnetic motor assembly for lift or power or other purposed machinery or design or cooling as needed or otherwise.

FIG. 11.—(FIG. I Focus)—This shows the car or transport base with fans in the base, front, and rear for mobility and/or cooling and maximizing transport efficiency and augment or powering mobilization capabilities as needed or advancing the machine or representative of the machine power capabilities, as well as turbine fan model design incorporating electromagnetic motor assembly.

### DETAILED DESCRIPTION

The present invention is directed to triple bullet magnet in wing gate design in electromagnetic motor assembly and system for energy amplification.

In its most complete form, the device is made up of the following components: The triple bullet magnet in wing gate design in electromotor assembly. The three bullet shaped magnets are connected in a stacked fashion but with separation on a rotary arm. They are polarized such that the negative positive of the top and lower bullet shaped magnets correspond to each other the same and to the opposite poles of the middle magnet, which would be positive negative, (opposite of the top and lower bullet (shaped) magnets). They are connected on their respective arm which swings in a rotary motion and there may be 4 arms, arms that are equally spaced, separated 90 degrees apart, but could include 3 or an alternate number symmetrically spaced. The shaft which they turn on is connected to an electromagnetic generator which produces power. That power can be utilized to drive any machine or alternately stored in the supercapacitor bank. The supercapacitor bank can be graphene or carbon based or otherwise. The supercapacitor bank is also charged by the copper wire circuitry leading in from the one-way junction gate or NPN type gate from the solar panel array. In a car, the solar panel array is arranged on the surface of the car. In another machine it can be arranged in the way most suitable for that transport or machine. The solar panel array on a car or transport or otherwise can be made of aluminum (or other suitable material) in a foil or series of folds type manner, triangular shaped panels may be used, but not exclusive to this design. The base of the aluminum fold may be silica or similar to help initiate flow of electricity through the copper way and solar panel array. The top edges outside the silica or otherwise base are coated with titanium oxide for maximum energy reflection. Use and the top of the panel includes polycarbonate or another material to both protect and maximize the energy absorption. The supercapacitors can be used to power any machine using the produced energy transmitted and correspondingly stored in the supercapacitor bank or from the assembly—to power the drivetrain, or fans, or electronics or any number of systems in a vehicle, transport, or other machine.

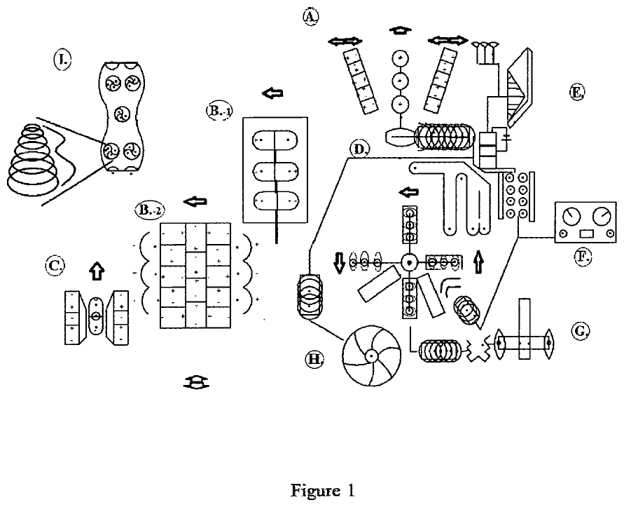

FIG. 1.—Portrait View—Shows an overview of the Triple Bullet Magnet in wing gate design and electromotor assembly and system for energy amplification. A) Shows the inline or sagittal view of the Triple bullet magnet in wing gate design and beginning of electromagnetic assembly that generates power B1.) Shows a lateral view or coronal view of the triple bullet magnet in wing gate design, showing a more central view highlighting the triple bullet magnet side view within the wing gates B2.) This shows a more lateral view of the lateral or coronal view, highlighting one of the more lateral wing gates side view C.) Shows a top down or aerial view of the triple bullet magnet in wing gate design D.) Shows a side or lateral view, coronal view of the full array, highlighting 4 Triple bullet magnet arms spaced, evenly, 90 degrees apart in rotary motion and the 5 wing gates at specific and unique interval spacing alongside the electromagnet pulse generator and also showing a coolant system E.) Shows the solar panel array and design with the triangular panels in the car or transport or machine exterior with folded or variegated aluminum structure with silicone wedge at base or valley of each fold with copper wire and polycarbonate protective top and titanium dioxide paint outside the silicon wedge base alongside transport of the electrical energy through an NPN type gate to the semiconductor bank (SC) F). Shows electronics being powered by the system G.) Shows a drivetrain being powered by system H.) Shows fans being powered by the system to be utilized in multiple purposes or transport or machines I.) Shows a car body, the base, or transport with fans powered in the base and front and rear and turbine fan design.

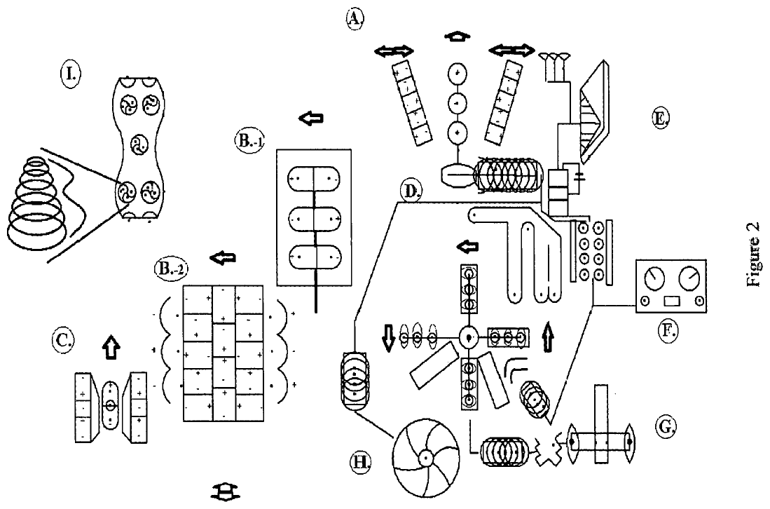

FIG. 2.—Landscape View—Same information as above.

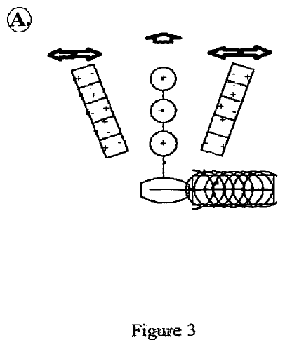

FIG. 3.—(FIG. A Focus)—Sagittal or in line view Triple bullet magnet in wing gate design—shows Triple bullet magnet in motion into the page inside the wing gate design and array and lateral movement capability of the wing gate—connected and turning shaft for electromotor energy—electrical output.

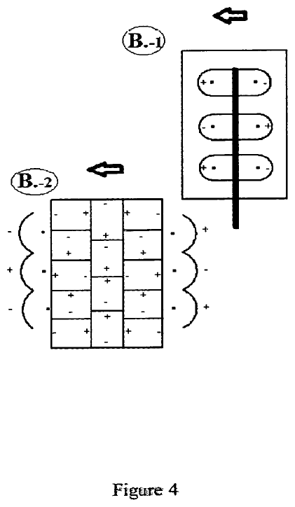

FIG. 4.—(FIGS. B1-B2 Focus)—Lateral or coronal view of the Triple Bullet Magnet in wing gate design. B1 shows a more central view that highlights the side view of the triple bullet magnet showing the bullet shaped magnets on the rotating arm. The 1st and 3rd magnets are aligned similarly with their poles in the same direction and the middle bullet shaped magnet has its poles aligned the opposite of the other two. The outline of the wing gate array is shown as a box around as a reference point to show the magnets passing in between 2 lateral gates. B2 shows the more peripheral or more lateral view of the side or lateral or coronal view of the wing gate design and array. It is a more detailed representation of the array of the wing gates and alignment of magnets and their respective poles within the make-up of the two wing gates. There is a wing gate on either side of the rotary bullet magnet arms as they are in motion past each gate.

FIG. 5.—(FIG. C Focus)—Top down or aerial view of a bullet magnet rotary arm passing between a stationary wing gate and wing gate array. The bullet arm has forward rotary movement and the wing gates have lateral movement capability toward the bullet shaped magnet arm or away.

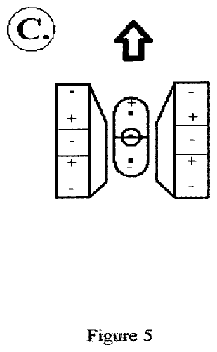

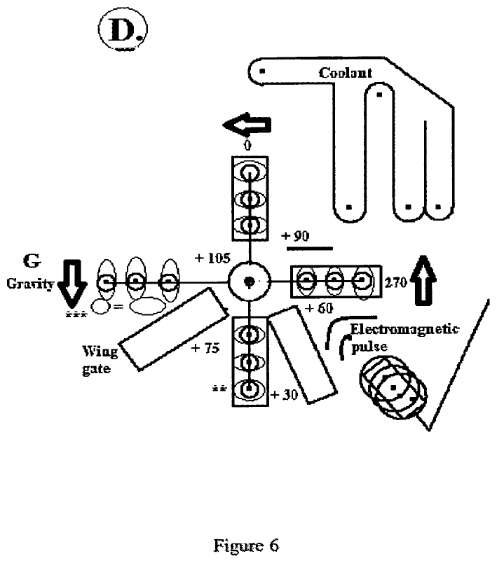

FIG. 6.—(FIG. D Focus)—This is the overall lateral vie bowing the 4 arms of the triple bullet magnet in rotary motion through the 5 wing gates. The 4 bullet shaped magnet arms are spaced evenly at 90 degrees apart in this model drawing (but could be 2 or 3 arms) and the 5 wing gate design showing the upright model with the first gate at the 0 degree mark at the top, the 2nd gate at the 105 degree mark going “downhill” with gravity, the 3rd gate on the 180 degree mark (plus 75 degrees from the previous), the 4th gate at the 210 degree mark (plus 30 degrees from the last one, and the 5th gate at the 270 degree mark (plus 60 degrees from the prior gate), taking us back to the 0 degree or 360 degree mark back up top (90 degrees from the 5th gate). There is an electromagnetic repulsion pulse generator, generated at the, variably, 45 degree mark going “uphill” from gravity past the 4th gate (at the 225 degree mark overall), and also angled variably, pitched to 25 degrees, upwards angle, to facilitate generating torque and acceleration and velocity control of the triple bullet magnet rotary arm in wing gate design. There is a coolant system to cool this system, and power generated in the assembly is coupled to generate power to the drivetrain, and or fans, electronics, machine, or supercapacitor bank via the electromagnet motor system to be stored and distributed as needed or appropriate. This represents the triple bullet magnet in wing gate design in the overall format, design, or assembly, or associated configuration.

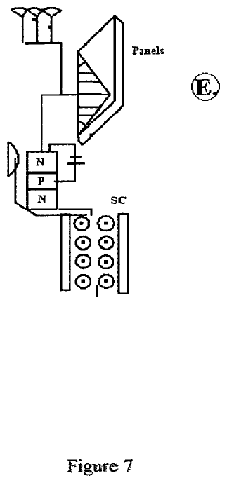

FIG. 7.—(FIG. E Focus)—Shows the corresponding solar type, clean energy array, such as ultraviolet or otherwise, that is structurally built into the integrity of the body, such as comprising the structure of the car or transport or machine. It is primarily an aluminum folded or variegated structure, with a ‘V’ or wedge shaped silica base at the depth or base of each groove in the depth or base of each fold, alongside copper wiring in that groove, separated from the aluminum on or within the silica base. There is titanium oxide painted outside the silica on the edges of the aluminum as the fold goes out to the top or apex of each fold. Covering the top of each V at the apex is a canopy of polycarbonate or similar and maximally productive scratch resistant substance transmitting the energy, light, or ultraviolet into each fold, which generates electricity and is channeled through a one way type gate, such as an NPN gate channel, and charging the supercapacitor bank to be distributed as needed or directed as called or utilized. The top 3 units diagrammed are seen, (such that they are V-shaped units at top of page with straight lines down representing the copper wires coming down from each and a curved canopy shaped window superior, on the top edge of each, which transmits the light and focuses the energy and provides some protection and energy conservation in a greenhouse effect). These 3 figures connected in a row show a cut out or blow-up example of the V shape, topped with a substance such as a polycarbonate or scratch resistant light permitting material, (3 in a row in this example representative of the ongoing and continuous variegated design pattern), where the silica base is wedged at the base of the groove and titanium oxide paint on the sides outside the silica base, along with the trailing lines inferiorly showing or representing the copper wiring leading out (in a representative way via the diagram schematic) and delivering electricity—via the one way electrical gate channel (NPN as a one way gate type example)—to the supercapacitor bank below. This can then feed into or give power as needed to the supercapacitor bank and on toward the rest of the assembly.

FIG. 8.—(FIG. F. Focus)—Shows the supercapacitor bank and such that it can supply power to any number of items within the car, transport or machine such as the representative electronics and electronic systems and power otherwise to or harnessed in the car, transport, or machine.

FIG. 9.—(FIG. G Focus)—Shows the drivetrain of the car or transport and gear box powered by the triple bullet magnet in wing gate assembly and electromotor assembly and with torque and drivetrain capabilities—alongside the write up at the bottom of the diagram which includes more written detail on wing gate design.

FIG. 10.—(FIG. H Focus)—Shows a tan or machine being powered by the Triple bullet magnet in wing gate design and electromagnetic motor assembly for lift or power or other purposed machinery or design or cooling as needed or otherwise.

FIG. 11.—(FIG. I Focus)—This shows the car or transport base with fans in the base, front, and rear for mobility and/or cooling and maximizing transport efficiency and augment or powering mobilization capabilities as needed or advancing the machine or representative of the machine power capabilities, and turbine fan design.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

### Additional Information

Although the version described here uses gravity in the upright position, the triple bullet magnet in wing gate design and electromotor assembly can be oriented in any position. The components while diagrammed in particular positions in the overall diagram, this is not intended to limit the order or arrangement of the assembly. We also are not limited by the types of array and arrangements shown here and format. We also have material options. There are many size options to the assembly and these design options could be any size.

What is claimed is:

1. An apparatus comprising:
An energy amplification device

2. A system comprising:
An energy amplification device including:
triple bullet magnet in wing gate design in electromagnetic motor assembly
solar type array structurally built into the integrity of the body
supercapacitor bank and such that it can supply power to any number of items
turbine fan design incorporating electromagnetic motor assembly as above
whereby any combination stated such that includes the triple bullet magnet in wing gate design electromagnetic motor assembly energy amplification apparatus
